(19) United States
(12) Patent Application Publication
(10) Pub. No.: US 2022/0200366 A1
(43) Pub. Date: Jun. 23, 2022

(54) STATOR TOOTH WITH ASYMMETRICAL TOOTH GEOMETRY

(71) Applicant: Rolls-Royce Deutschland Ltd & Co KG, Blankenfelde-Mahlow (DE)

(72) Inventors: Johannes Gabriel Bauer, Neuried (DE); Daniel Merz, München (DE)

(21) Appl. No.: 17/600,096

(22) PCT Filed: Mar. 31, 2020
(86) PCT No.: PCT/EP2020/059125

§ 371 Date: Sep. 29, 2021

(30) Foreign Application Priority Data
Apr. 10, 2019 (DE) 10 2019 205 153.7

(51) Int. Cl. H02K 1/14; H02K 15/085

(52) U.S. Cl. CPC H02K 1/146; H02K 2201/12; H02K 15/085

(57) ABSTRACT

A tooth for a stator of an electrical machine and geometry of a tooth head region of a stator tooth are provided. In the case of a typical radial flux machine with an external stator and an internal rotor, the tooth head region has an asymmetry in an axial direction of view that is created by the fact that a recess is provided at a first tangential end of the tooth head region. A position of the first tangential end depends on a preferential direction of rotation of the rotor of the electrical machine and is chosen such that it is situated at a rear end of the head region when viewed in the preferential direction of rotation of the rotor.

This application is the National Stage of International Application No. PCT/EP2020/059125, filed Mar. 31, 2020, which claims the benefit of German Patent Application No. DE 10 2019 205 153.7, filed Apr. 10, 2019. The entire contents of these documents are hereby incorporated herein by reference.

### BACKGROUND

The present embodiments relate to a tooth for a stator of an electrical machine and, for example, to the geometry of the tooth head region of the stator tooth.

As an alternative to the usual internal combustion engines, concepts based on electric drive systems are being tested and used for propelling aircraft (e.g., airplanes or helicopters) or also for electrically powered watercraft etc. An electric or hybrid-electric drive system of this type generally has one or a plurality of electrical machines that, depending on the specific application in the drive system, may be configured as generators and/or as electric motors.

A drive concept that may be used for such mobile applications is based, for example, on direct drive in which the electrical machine is directly connected (e.g., without a transmission) to a propulsion device to be driven (e.g., a propeller). In direct drive systems, for example, high torque densities are required to be able to generate the power levels necessary for propulsion. In general, electric drives for applications involving a requirement for high torques and low speeds of rotation may be implemented with the aid of high-speed or rapidly rotating machines with a transmission or, alternatively, using machines designed for high torque densities. Dispensing with a transmission in the case of electrical machines with a high torque density brings with it the advantage that the complexity and weight of the overall system may be reduced. In this case, the required torque is fully supplied by the now slowly rotating machine. The electromagnetic designs that are typically suitable for this purpose are often distinguished by the fact that the electromagnetic designs have a relatively large air gap diameter, a short axial length, a small or narrow air gap, and a high pole pair number with a fine pole pitch of the permanent magnets mounted on the surface of the rotor.

Owing to the fine pole pitch in the rotor, however, there arises at the air gap a magnetic leakage flux having field lines, although the field lines enter and exit at the rotor poles, that are not enclosed by the stator core and thus do not participate in the conversion of electric power to mechanical power. The fact that tangential force components that lead to unwanted “torque ripple” and oscillating torques arise from the leakage flux or the corresponding magnetic leakage field has a disadvantageous effect. The normal components of these forces impose loads on the structure of the electrical machine and may lead to the excitation of acoustically perceptible vibrations and possibly to damage of the machine.

The magnetic leakage fields of the permanent magnets of the rotor pass through the stator iron at the location of the stator teeth and cause increased iron losses there as well as an increased degree of saturation of the material. Consistent with this, the magnetic resistance for the main magnetic flux that ultimately forms the torque rises, and this is to be compensated by higher currents in the stator windings, but this increases resistance losses as a result. This is explained in greater detail in the context of the description of the figures in conjunction with FIG. 2.

A reduction in the magnetic leakage field could be achieved by increasing the magnetic resistance, for example. This is achieved by a larger spacing between the rotor poles or a reduction in the pole pair number with the same air gap diameter. Alternatively or in addition, the leakage field may be reduced by widening the air gap, which increases the distance covered by the leakage field lines in air. Likewise as an alternative or in addition, a reduction in the tooth width may also increase the magnetic resistance for the rotor leakage field. However, all these measures have an attenuating effect on the flux linkage between the main flux and the useful shaft torque, and therefore, the efficiency of the machine is impaired.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a way of increasing magnetic resistance in order to reduce a magnetic leakage field is provided.

A component for a stator of an electrical machine having the stator and a rotor is provided. The component is intended for guiding a main magnetic flux of a stator winding of the stator. The component is provided, configured, and arranged in order, during the operation of the electrical machine (e.g., when there is current flowing through the stator winding) to guide the main magnetic flux caused by this current flow. The component has a neck region and a head region that faces a rotor of the electrical machine in the installed state in the machine. The component has an asymmetry, at least in the head region, when viewed in an axial or optionally radial direction.

In contrast to the magnetic leakage flux, the main magnetic flux mentioned here and below is the magnetic flux that is intended to interact electromagnetically with the permanent magnets of the rotor, or the fields thereof, in order to produce the torque of the machine.

The respective asymmetry is achieved, for example, by in each case providing a recess at a first tangential end of the respective head region. In addition to the desired effect already explained, the presence of a recess of this kind also provides the possibility of inserting the respective stator tooth positively into a corresponding supporting structure of the stator.

The respective recess may be shaped in such a way, for example, that the respective recess has a rectangular profile in the axial direction of view.

It is possible, for example, for the component to be a stator tooth that guides the main magnetic flux that may be generated by a stator winding.

In a special refinement, the component or tooth may be configured as a claw (e.g., as a claw pair) for the stator of the electrical machine, which is configured as a claw pole stator. In this case, the electrical machine is configured as a transverse flux machine.

Further, the component may have a further head region at the opposite end of the neck region from the head region. The further head region faces a further rotor of the electrical machine in the installed state in the machine, where the component has a further asymmetry in the further head region when viewed in the axial direction of view. This is advantageous for electrical machines with a double rotor or a double air gap, for example.

A stator for an electrical machine having this stator and a rotor has a stator winding for generating a main magnetic flux, and an asymmetrical component of this kind for guiding the main magnetic flux. The stator winding and the component are arranged in such a way relative to one another that the main magnetic flux generated by the stator winding during the operation of the electrical machine is guided by the component.

In this case, the component may be a stator tooth that extends from a stator ring of the stator toward the rotor in the radial direction and carries the stator winding such that the stator winding is wound around the stator tooth, at least in the neck region. The stator tooth typically has a tooth foot that is secured on the stator ring or forms the stator ring together with the tooth feet of the further stator teeth of the stator. The tooth neck extends between the tooth foot and the tooth head. The stator winding or at least part thereof is located on the stator tooth, and therefore, the tooth guides the main magnetic flux. Owing to the asymmetry achieved by the recess in the head region, the abovementioned advantage is then obtained.

In one embodiment, the stator may be configured as a claw pole stator. The component then forms a claw pair of the claw pole stator. In this case, the electrical machine is configured as a transverse flux machine.

The stator may have a structure into which the component is inserted by a region having the asymmetry such that positive engagement is obtained between the component and the structure. This provides that the component remains in place, even in the presence of the high forces that are to be expected.

A corresponding electrical machine includes a stator of this kind and a rotor that, during the normal operation of the machine, rotates, for example, in a preferential direction of rotation T.

The component is built into the stator such that the respective first tangential end of the respective head region of the component is situated at the rear end of the respective head region when viewed in the preferential direction of rotation T of the rotor from the center of the head region.

The respective recess forming the asymmetry extends from a surface of the respective head region that is situated opposite the respective rotor, the surface lying opposite the rotor such that the air gap extends between this tangential surface and the rotor, by an extent XR and from a tangential surface of the respective head region by an extent XT into the respective head region. In this case, XR corresponds substantially to twice the radial extent R150 of the air gap of the electrical machine formed between the stator and the rotor, while XT corresponds substantially to 20% of the tangential extent T122a of the respective head region. In the axial direction, the recess extends over the entire component. In this configuration, it is to be expected that the desired effect is maximized with, at the same time, a minimum negative effect on the main magnetic flux.

In one embodiment, this electrical machine is suitable for a drive system of an electric aircraft. Depending on the intended use, this machine may be configured as an electric generator or, alternatively, as an electric motor for driving a propeller of the aircraft.

Further advantages and embodiments may be found in the drawings and the corresponding description.

The exemplary embodiments will be explained in more detail below with reference to drawings. There, the same components are identified by the same reference signs in various figures. It is therefore possible that, when a second figure is being described, no detailed explanations will be given of a specific reference sign that has already been explained in relation to another, first figure. In such a case, it may be assumed for the embodiment of the second figure that, even without detailed explanation in relation to the second figure, the component identified there by this reference sign has the same properties and functionalities as explained in relation to the first figure. Further, for the sake of clarity, in some cases, not all the reference signs are shown in all of the figures, but only those to which reference is made in the description of the respective figure.

### BRIEF DESCRIPTION OF THE DRAWINGS

FIG. 1 shows a known electrical machine;

FIG. 2 shows an axial view of two stator teeth according to the prior art;

FIG. 3 shows an axial view of two stator teeth according to an embodiment;

FIG. 4 shows an axial view of two stator teeth according to a first variant;

FIG. 5 shows an axial view of a stator tooth according to a second variant;

FIG. 6 shows a perspective view of a section of a transverse flux machine having stator teeth according to an embodiment;

FIG. 7 shows a claw pole pair of the transverse flux machine in FIG. 5; and

FIG. 8 shows two stator teeth according to an embodiment for a radial flux machine having a double rotor.

### DETAILED DESCRIPTION

Terms such as “axial”, “radial”, “tangential”, etc. relate to a shaft or axis used in the respective figure or in the example described in each case. In other words, each of the directions axial, radial, and tangential relate to a respective axis of rotation of the rotor. “Axial” herein describes a direction parallel to the axis of rotation, “radial” describes a direction orthogonal to the axis of rotation, toward or away from the axis of rotation, and “tangential” is a movement or direction, respectively, that is directed in a circle around the axis of rotation at a constant radial spacing from the axis of rotation and with a constant axial position.

Further, the terms “axial”, “radial”, or “tangential”, respectively, in the context of an area (e.g., a surface) provide that the normal vector of the respective axial, radial, or tangential surface is oriented in the axial, radial, or tangential direction, whereby the orientation of the respective area in space is unequivocally described.

In connection with components (e.g., rings or webs), the term “adjacent” is intended to express the fact that, in the case of “adjacent components”, there is, for example, no further such component between these two components but at most an empty intermediate space.

The expression “coaxial components” (e.g., coaxial rings) may be components that have identical normal vectors, for which, therefore, the planes defined by the coaxial components are parallel to one another. Further, the expression is intended to imply that, although the central points of coaxial components lie on the same axis of rotation or symmetry, the central points of coaxial components may in some cases lie on this axis at different axial positions, and the planes are thus at a distance>0 from one another. The expression does not necessarily require that coaxial components have the same radius.

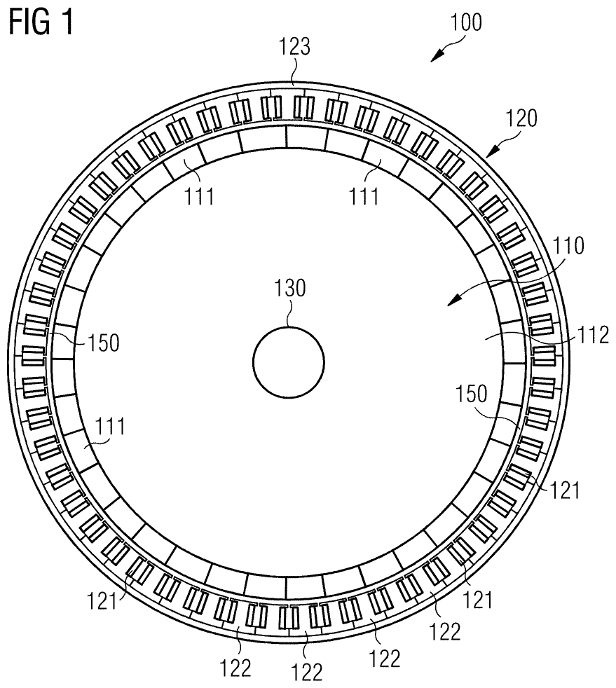

FIG. 1 shows by way of example an electrical machine 100 configured as an electric motor, of the kind known in the prior art. The electrical machine 100, in a similar structure, may also be operated as a generator in principle. Further, the construction of the machine described hereunder is greatly simplified and moreover does not show some of the details explained in connection with the other figures, but rather serves only to illustrate the fundamental functional mode of the electric motor. It may be assumed to be known that the various components of the machine may be disposed differently, depending on the configuration of the electrical machine as a generator or as an electric motor and/or as, for example, a radial or axial flow machine with a rotor configured as an internal or external rotor, etc.

The electric motor 100 has a substantially annular stator 120 and a substantially cylindrical rotor 110, formed as an internal rotor. The rotor 110 is arranged within the stator 120 and, in the operating state of the electric motor 100, rotating about an axis of rotation. The rotor 110, or a substantially cylindrical rotor main body 112 of the rotor 110, is connected to a shaft 130 for conjoint rotation therewith, so that a rotation of the rotor 110 may be transmitted via the shaft 130 to a component to be driven (not shown) (e.g., to a propeller of an airplane).

The stator 120 has a first magnetic device 121 that may be implemented, for example, as stator windings 121. Each of the windings 121 is formed by an electrical conductor. The conductors 121 have in each case been wound onto a stator tooth 122 of the stator 120, and, in the operating state of the electric motor 100, an electric current flows through the conductors so that magnetic fields are generated. The stator teeth 122 are fastened on a stator ring 123. The rotor 110 has a second magnetic device 111 that may be configured as permanent magnets 111, for example, and may be arranged on a surface of the rotor main body 112 facing the stator 120. For the sake of clarity, only a few permanent magnets 111 are provided with a reference sign.

The first magnetic device 121 and the second magnetic device 111 (e.g., magnetic devices) are configured and spaced apart from one another by an air gap 150 such that the first magnetic device 121 and the second magnetic device 111 interact electromagnetically with one another in the operating state of the electric motor 100. This concept, including the conditions for the design and precise arrangement of the magnetic devices 111, 121 or of the rotor 110 and stator 120, are known per se and therefore will not be explained in more detail below. In order to operate the electrical machine 100 as an electric motor, the stator windings 121 are supplied with an electric current with the aid of a power source 200 (not illustrated). The electric current causes the windings 121 to generate corresponding magnetic fields that come to interact electromagnetically with the magnetic fields of the permanent magnets 111 of the rotor 110. This results in a torque acting in a first tangential direction T on the permanent magnets 111, which, provided that the permanent magnets 111 are connected sufficiently firmly to the rotor main body 112, results in the rotor 110 and conjointly therewith the shaft 130 being set in rotation when the components are suitably configured and arranged in relation to one another.

This concept of designing the electrical machine 100 as an electric motor may be assumed to be known. The corresponding configuration and use of the electrical machine 100 as a generator may also be assumed to be known. The two designs of the electrical machine 100 are not therefore detailed any further below.

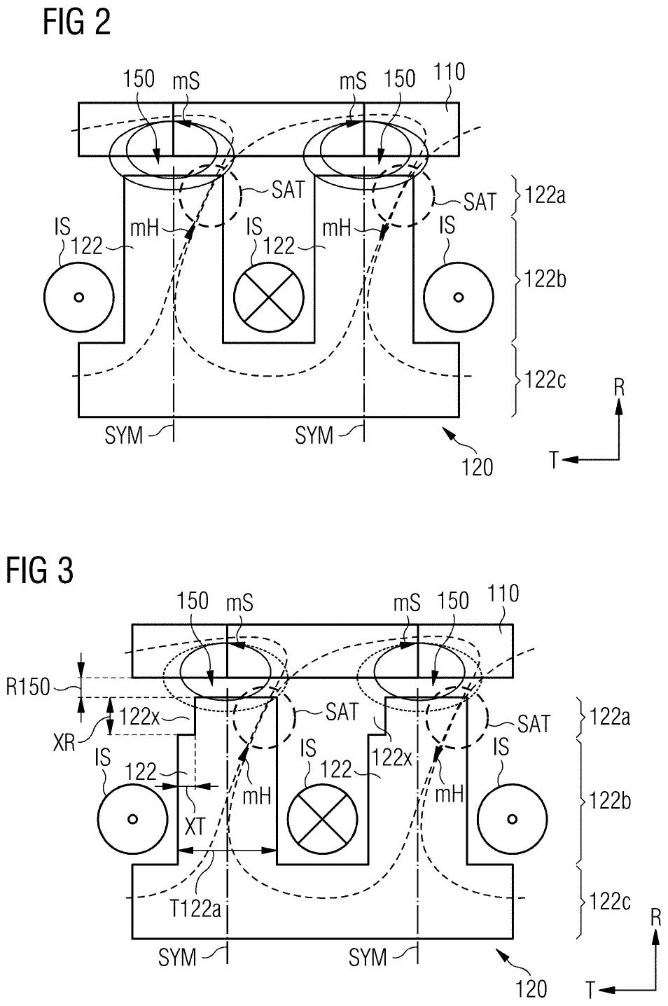

FIG. 2 shows an axial view of two of the stator teeth 122 according to the prior art with the stator currents IS flowing through the windings 121 (not illustrated here) and the resulting main magnetic flux mH. As already described at the outset, the fine pole pitch in the rotor 110 results in the magnetic leakage flux mS at the air gap 150. These magnetic leakage fields mS of the rotor 110 pass through the stator iron at the location of the stator teeth 122 (e.g., in the tooth head region 122a thereof). The interaction between the magnetic fluxes mH and mS results, particularly in the areas SAT indicated by dashed lines, in regions with a high degree of saturation of the material present there or premature saturation, associated with increased iron losses. Consistent with this, the magnetic resistance for the main magnetic flux mH that ultimately forms the torque rises, and this is to be compensated by higher currents IS in the stator windings 121, something that should be avoided, as described at the outset.

FIG. 3 likewise shows the axial view of two of the stator teeth 122 with the stator currents IS flowing through the windings 121 (not illustrated here either) and the resulting main magnetic flux mH. In contrast to the prior art, however, the respective geometry of the stator teeth 122 is now asymmetrical in the axial direction of view. This is achieved by virtue of the fact that the stator teeth 122 have recesses 122x in the tooth head regions 122a. The axes of symmetry SYM are indicated for each of the illustrated teeth 122 by the dashed line. The asymmetrical tooth head geometry makes it possible to increase the magnetic resistance for the rotor leakage field mS independently of that of the main flux mH. In the best case, a separation between the rotor leakage flux path and the main flux path is achieved in designing the magnetic circuit. In general, a lower leakage flux mS is now observed in the areas SAT, and this provides that there is additional potential for guiding the main flux mH at these locations, thus enabling the abovementioned disadvantages to be very largely avoided.

In the design of the stator 120 with respect to the positioning of the recess 122x on the stator tooth 122, particularly in the tangential direction T, the intended direction of rotation of the rotor 120 during the operation of the electrical machine 100 is to be taken into account. In FIG. 3, it is assumed that the tangential force component on the rotor 110 acting during the operation of the machine 100 by reason of the electromagnetic interaction between the stator windings 121 and the permanent magnets 111 is directed to the left in accordance with the positive tangential T direction in the illustrated R, T coordinate system. Consistent with this, the rotor 110 rotates to the “left”. Accordingly, the “left-hand” region in the tooth head 122a participates only slightly in the guidance of the main flux mH. By cutting away stator material in this region, the recess 122x is formed. This is associated with a significant increase in the magnetic resistance for the rotor leakage fields mS. This results in a reduction in the rotor leakage flux mS, while the effect on the main magnetic flux mH is slight or negligible.

Thus, the recesses 122x are provided at that tangential end of the tooth head region 122a that lies in the direction corresponding to the direction of rotation of the rotor 110 when viewed from the tooth center. Thus, the recesses 122x are situated at the rear end of the respective tooth head region 122a when viewed in the direction of rotation T of the rotor 110. This results in a preferential direction of rotation of the electrical machine 100 equipped with the stator teeth 122 provided with recesses 122x. This is not a disadvantage for the use provided here as a motor for driving a propeller of an aircraft since this propeller is generally always operated in the same direction of rotation. The same applies in uses such as those in many traction, pump, compressor, tool, and fan drives, in which symmetrical behavior is not required and therefore an asymmetrical torque constant may be accepted. Operation in the opposite direction is possible in principle, but the efficiency and possibly the torque of the motor operated in this way would be significantly lower than during operation in the preferential direction of rotation.

The individual recesses 122x are dimensioned such that a radial extent XR of the individual recesses 122x corresponds substantially to twice a radial extent or thickness R150 of the air gap 150. In the tangential direction, the extent XT or the respective recess 122x corresponds substantially to 20% of the tangential extent T122a of the tooth head region 122a in which the recess 122x is arranged. In the axial direction, the recess 122x extends over the entire tooth 122 (e.g., in the usual case where the stator tooth 122 consists of a number of individual laminations stacked one on top of the other in the axial direction, each individual lamination of a respective tooth 122 has a corresponding recess).

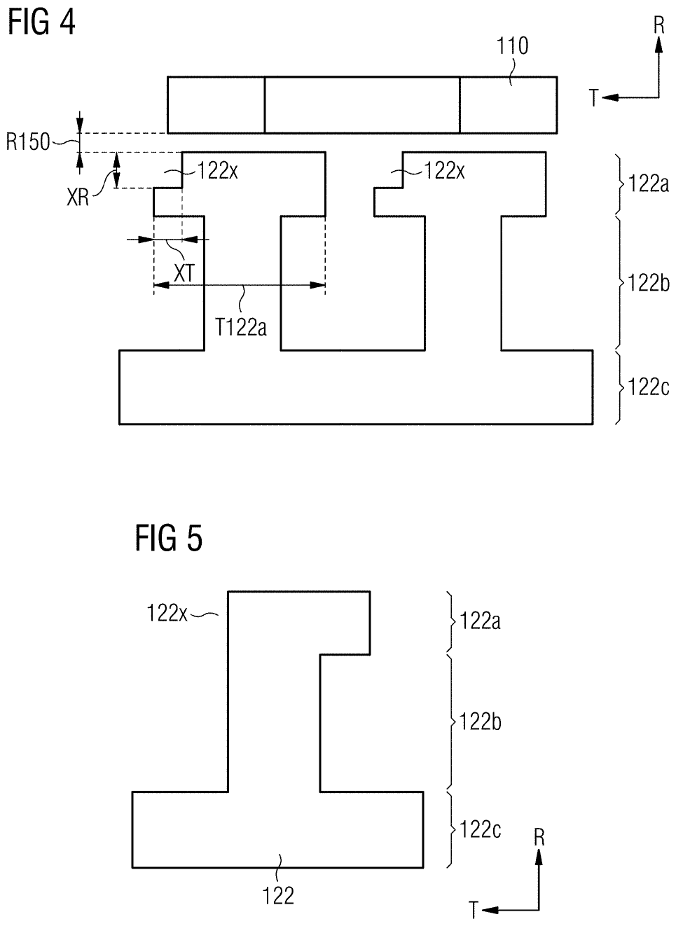

FIG. 4 shows essentially the same situation as FIG. 3, but the tooth head regions 122a of the stator teeth 122 are each configured such that the tooth head regions 122a extend beyond the respective tooth neck 122b in the positive and in the negative tangential direction T. This geometry is not unusual and is therefore not explained in greater detail below. Even where this tooth shape is present, it is possible to position a recess 122x in the tooth head region in order to achieve the abovementioned advantages.

The design illustrated in FIG. 5 goes one step further. Here, the recess 122x is formed by virtue of the fact that the tooth head regions 122a of the stator teeth 122 extend beyond the respective tooth neck 122b in only one tangential direction T. In other words, the radial extent XR of the recess 122x thus corresponds to, for example, the radial extent of the tooth head region 122a.

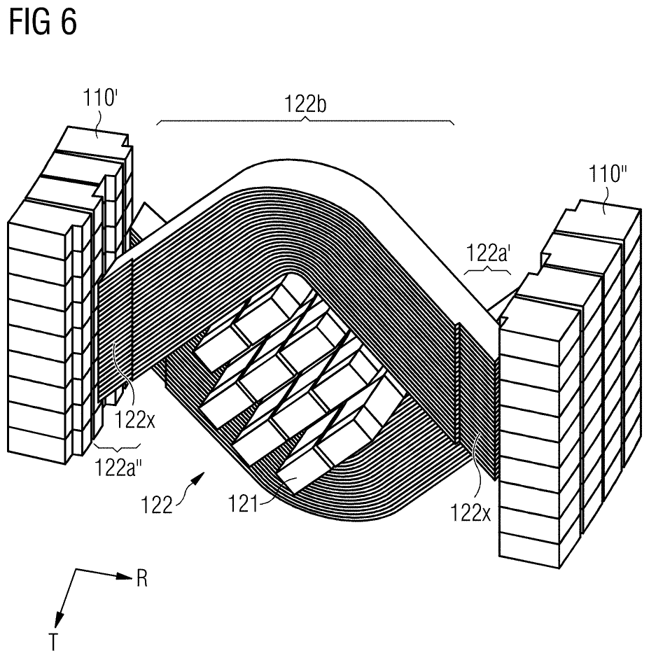

In principle, the approach described in conjunction with FIGS. 3, 4, and 5 is independent of machine topology. FIGS. 3, 4, and 5 indicated the situation for a typical radial flux machine 100 having a stator 120 and a rotor 110 configured, for example, as an internal rotor. In contrast, FIG. 6 shows the configuration of a transverse flux machine 100 having a double rotor 110. The machine 100, which is configured for maximum torque densities, uses a double rotor 110 having a first rotor component 110′ and a second rotor component 110″. Each of the rotor components 110′, 110″ has surface magnets 111. The stator 120, which is arranged between the rotor components 110′, 110″ when viewed in the radial direction R, has a stator winding 121 that is configured substantially as a ring winding. Here, the stator tooth 122, which once again has recesses 122x, is configured as a claw pair in order to guide the main magnetic flux mH generated by the ring windings 121 (e.g., the stator 120 is implemented as a claw pole stator 120). The recesses 122x are once again situated in the respective tooth head region 122a, where the tooth or claw pair 122 has two head regions 122a′, 122a″ in accordance with the configuration of the machine 100 with two rotor components 110′, 110″. The neck region 122b extends in the radial direction R between the two head regions 122a′, 122a″. In the respective head region, the recesses 122x are once again arranged in accordance with the preferential direction of rotation T of the double rotor 110 (e.g., such that the recesses 122x are provided at that tangential end of the respective head region 122a′, 122a″ that, when viewed from the tooth center, lies in the direction corresponding to the preferential direction of rotation T of the double rotor 110). Thus, the recesses 122x are situated at the rear end of the respective head region 122a′, 122a″ when viewed in the direction of rotation T of the double rotor 110.

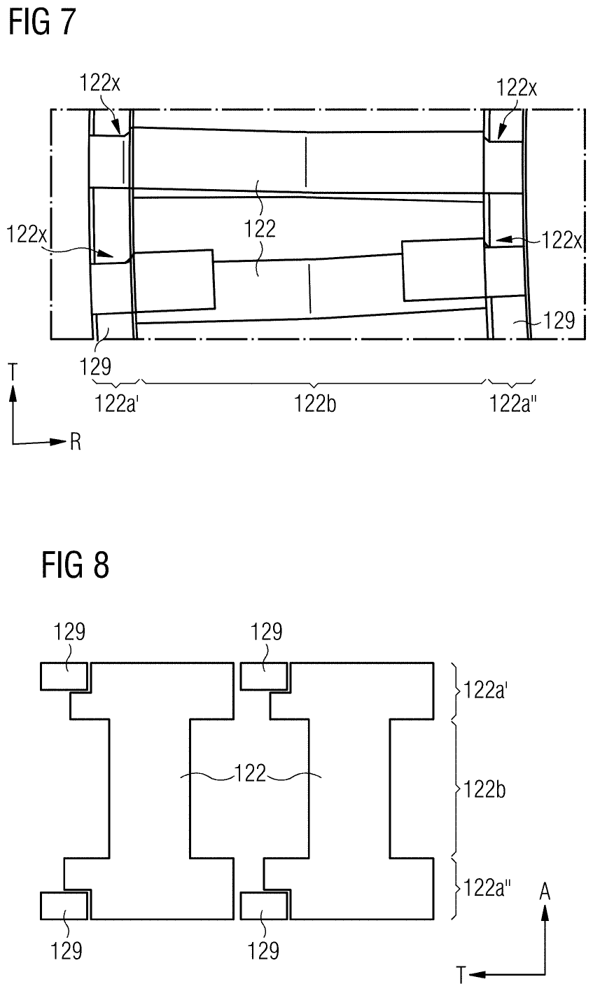

With the topology involving a double air gap illustrated in FIG. 6, for example, the presence of the recesses 122x has a positive effect, in addition to the already explained positive, weakening effect on the magnetic leakage flux mS, inasmuch as positive engagement may be created between the stator teeth 122 and a correspondingly configured structure 129 of the stator 120 by virtue of the recesses 122x. This is made clearer in FIG. 7, which illustrates a segment of a stator 120 including two annular structures 129, into which the teeth 122 are inserted such that the tooth head regions 122a extend into the respective structure 129. For example, laminations forming the tooth 122 cannot slide into the air gap 150, even if the adhesive holding the laminations together fails, owing to the steps in the tooth head region 122a that are formed by the recesses 122x. Thus, this has a positive effect on the operational reliability of the machine 100.

In the case where the machine 100 has the topology illustrated in FIG. 6, for example, the structure 129 may include two or more stator tubes 129. Particularly in corresponding tooth head regions 122a, the teeth 122 are inserted into the stator tubes 129 and are thus additionally fixed in order to support the adhesive used for fixing. The presence of the recesses 122x allows positive engagement between the teeth 122 and the structure 129.

FIG. 8 shows an alternative thereto. In the case indicated here, the machine 100 is configured as a radial flux machine having a double air gap 150. The stator 120 also has structures 129 that are used for the fixing of the stator teeth 122. For this purpose, the teeth 122 and the structures 129 are arranged in such a way relative to one another that the structures 129 are situated at the locations of the recesses 122x and may thus bring about positive engagement, providing that the teeth 12 are fixed.

In contrast to the above embodiments, in which the asymmetry in the respective head region 122a was visible when viewed axially, the asymmetry due to the recesses 122x in this embodiment appears when viewed radially. In all the embodiments, however, the recess 122x is situated at a tangential end of the respective head region 122a, 122a′, 122a″ (e.g., the tangential end that is situated in the direction corresponding to the direction of rotation of the rotor 110 when viewed from the tooth center).

In the examples illustrated, the recesses 122x are rectangular when viewed in the respective direction of view. Other shapes may be provided. For example, the recesses 122x may have round, beveled, or other profiles in the axial direction of view instead of the illustrated rectangular profile.

To produce asymmetrical stator teeth 122 of this kind, it is possible to employ conventional manufacturing methods. Stator teeth 122 are typically of laminated design (e.g., consist of a number of sheet metal layers stacked one on top of the other in the axial direction). The tooth head geometry described may be taken into account without any special additional effort in the known processes in stator lamination manufacture (e.g., laser cutting or punching).

As indicated at the outset, the electrical machine constructed in this way may be used in a drive system of an electric aircraft (e.g., as a motor for driving a propeller or as a generator for providing electrical energy on board the aircraft).

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A component for a stator of an electrical machine having the stator and a rotor, the component being operable to guide a main magnetic flux of a stator winding of the stator, the component comprising:
a neck region and a head region that faces the rotor of the electrical machine in an installed state in the electrical machine,
wherein the component has an asymmetry, at least in the head region.

2. The component of claim 1, wherein the component is a stator tooth.

3. The component of claim 1, wherein the component is a claw for the stator of the electrical machine, which is configured as a claw pole stator.

4. The component of claim 1, wherein the head region is a first head region, and the rotor is a first rotor,
wherein the component further comprises a second head region at an opposite end of the neck region from the first head region, the second head region facing a second rotor of the electrical machine in the installed state in the machine, and
wherein the component has a further asymmetry in the second head region.

5. The component of claim 1, wherein the asymmetry is achieved by each case providing a recess at a first tangential end of the head region.

6. The component of claim 5, wherein the recess is shaped such that the recess has a rectangular profile.

7. A stator for an electrical machine having the stator and a rotor, the stator comprising:
a stator winding operable to generate a main magnetic flux; and
a component operable to guide the main magnetic flux, the component comprising a neck region and a head region that faces the rotor of the electrical machine in an installed state in the electrical machine, wherein the component has an asymmetry, at least in the head region,
wherein the stator winding and the component are arranged in such a way relative to one another that the main magnetic flux generated by the stator winding during operation of the electrical machine is guided by the component.

8. The stator of claim 7, wherein the component is a stator tooth that extends from a stator ring of the stator toward the rotor and that carries the stator winding such that the stator winding is wound around the stator tooth, at least in the neck region.

9. The stator of claim 7, wherein the stator is configured as a claw pole stator, and
wherein the component forms a claw pair of the claw pole stator.

10. The stator of claim 7, wherein the stator has a structure into which the component is inserted by region of the component having the asymmetry such that positive engagement is obtained between the component and the structure.

11. An electrical machine comprising:
a stator comprising:
a stator winding operable to generate a main magnetic flux; and
a component operable to guide the main magnetic flux, the component comprising a neck region and a head region that faces a rotor of the electrical machine in an installed state in the electrical machine, wherein the component has an asymmetry, at least in the head region, and wherein the stator winding and the component are arranged in such a way relative to one another that the main magnetic flux generated by the stator winding during operation of the electrical machine is guided by the component; and
the rotor having a preferential direction of rotation.

12. The electrical machine of claim 11, wherein the component is built into the stator such that a first tangential end of the head region of the component is situated at a rear end of the head region when viewed in the preferential direction of rotation of the rotor.

13. The electrical machine of claim 11, wherein the recess forming the asymmetry extends from a surface of the head region facing the rotor by an extent and from a tangential surface of the head region by an extent into the head region,
wherein the extent corresponds substantially to twice a radial extent of the air gap of the electrical machine formed between the stator and the rotor, and
wherein the extent corresponds substantially to 20% of a tangential extent of the head region.

14. An electric aircraft comprising:
a drive system comprising:
an electrical machine comprising:
a stator comprising:
a stator winding operable to generate a main magnetic flux; and
a component operable to guide the main magnetic flux, the component comprising a neck region and a head region that faces a rotor of the electrical machine in an installed state in the electrical machine, wherein the component has an asymmetry, at least in the head region, and wherein the stator winding and the component are arranged in such a way relative to one another that the main magnetic flux generated by the stator winding during operation of the electrical machine is guided by the component; and
the rotor having a preferential direction of rotation.

15. The component of claim 3, wherein the claw is a claw pair.
